(19) United States
(12) Patent Application Publication
(10) Pub. No.: US 2005/0168459 A1
(43) Pub. Date: Aug. 4, 2005

(54) System and method for packaging design

(76) Inventor: Andrew Baird, Denver, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(21) Appl. No.: 09/934,131

(22) Filed: Aug. 21, 2001

Related U.S. Application Data
(60) Provisional application No. 60/226,802, filed on Aug. 21, 2000.

(51) Int. Cl. G06T 15/00

(52) U.S. Cl. 345/419; 700/97; 715/964

(57) ABSTRACT

A system and process for creating three-dimensional renderings of packaging designs. The system is able to import two-dimensional die lines and convert them into two-dimensional structural drawing. The cut lines, crease lines and boundary lines are converted into guide lines to allow design elements to be added to the drawing. Three-dimensional views can then be rendered from this two-dimensional structural drawing. Modifications to the design can be made and saved. The three-dimensional views can be exported for viewing.

### RELATED APPLICATIONS

This application is related to subject matter of provisional application 60/226,802, filed on Aug. 21, 2000.

### FIELD OF THE INVENTION

This invention relates to the field of packaging design and particularly to the field of graphically designing packaging from a layout drawing.

### BACKGROUND OF THE INVENTION

The design of packaging for products has become an important marketing tool. The presentation of the product packaging provides a critical impact in the appeal of the product to the consumer. The design of the product packaging includes input from structural engineers to graphic designers to marketing personnel to clients and others. Previously, the engineer would design a structural container and create a physical mock-up. The graphic designer would then cut and paste design elements on the mock-up for evaluation. Changes would require another physical mock-up. This process was cumbersome and time-consuming.

Tools were created to automate some these tasks. Presently, packaging designers typically create a “die line” of the package, with Computer Aided Design software. The die line displays the cut-outs and bends of the package in a planar form. This allows a die to be made that will make the appropriate die cuts in the sheets (such as cardboard, plastic, paper, etc.) on which the package graphics have been printed. The die-cut sheets can then be folded into the appropriate container shapes.

The packaging designer normally converts the CAD die line drawing into a format that will allow an image editing software packaging to be used for designing graphics for the packaging. For example, the die-line drawing may be converted into Encapsulated PostScript (EPS) format. The packaging designer may then open that converted file into an image editing program, such as QuarkXPress by Quark, Inc., or other software packages. The designer will then add the appropriate graphics and text to the converted file. This file is then outputted as an EPS file or other file suitable for printing. The packaging sheets are then printed in accordance with this file.

Numerous problems occur with this workflow process. One such problem is need for several packages to provide the conversion, editing and output of the design drawings. Another problem is the inability to accurately visualize the final appearance of the assembled package prior to the printing and assembly of the container. Presently, the designer creates a physical mock-up of the container to ensure that graphics are in the appropriate place on the drawing. This is a particular problem with complex containers that have a plurality of folds.

Previous attempts to solve these problems were largely unsuccessful. One such attempt is disclosed in U.S. Pat. No. 4,796,201, issued to Wake. This patent disclosed a system that wrapped graphics about a three-dimensional structure chosen from a library. It did not address working with a two-dimensional structural drawing or exporting views.

Thus, a need exists for the ability to design packaging from two-dimensional die line drawings, adding design elements, making modifications and rendering for viewing and exporting of three-dimensional views of the packaging.

### SUMMARY OF THE INVENTION

A preferred embodiment of the present invention solves these and other problems by providing a system for formatting text and graphics in two dimensions on a die-line drawing, rendering and exporting this design in three dimensions, and outputting the finished design for printing.

The system is able to directly import a die line structure, such as a CAD drawing, directly into the system to create a two-dimensional structural drawing. The crease, boundary and cut lines on the die line drawing are represented as guides to ensure precise alignment of images, text and other design elements. New boxes and lines can be added as well.

Design elements may be added to the two-dimensional structural element from a library or created. These design elements can include text, graphics, even Bezier lines and other design features.

The package structure can then be rendered into a three-dimensional image on a computer screen. An animation of the actual folding and/or assembly process can be viewed as well. The assembled package structure can be viewed from any angle or viewpoint.

Views of the structure can be exported to allow collaborative editing of the structure. Multiple designers, managers and clients can electronically view and verify the mock-up to reduce the time and cost of the package design process. The system also allows structural changes to be made in the rendered three-dimensional image.

These and other features are evident in the ensuing detailed description of preferred embodiments and from the drawings.

### BRIEF DESCRIPTION OF THE DRAWINGS

FIG. 1 is an illustration of a workflow chart of a preferred embodiment of the present invention.

FIG. 2 is a schematic drawing of a two-dimensional die line of the embodiment of FIG. 1.

FIG. 3 is a two-dimensional view of the two-dimensional die line of FIG. 3 imported into the system.

FIG. 4 is a screen shot of the design elements for creating the packaging design for the die line of FIG. 2.

FIG. 5 is a screenshot of the assembly animation of the packaging design of FIG. 4.

FIG. 6 is another screenshot of the three-dimensional assembly animation of the packaging design of FIG. 4.

FIG. 7 is another screenshot of the three-dimensional assembly animation of the packaging design of FIG. 4.

FIG. 8 is another screenshot of the three-dimensional assembly animation of the packaging design of FIG. 4.

FIG. 9 is a screenshot of a three-dimensional view of the assembled packaging design of FIG. 4.

FIG. 10 is a screenshot of a three-dimensional view of the assembled packaging design of FIG. 4.

FIG. 11 is a screenshot of a three-dimensional view of the assembled packaging design of FIG. 4.

FIG. 12 is an illustration of the rendering workflow of a preferred embodiment of the present invention.

### DETAILED DESCRIPTION OF PREFERRED EMBODIMENTS

The present invention provides systems and methods for designing packaging and graphics for packaging. It is to be expressly understood that the descriptive embodiments set forth herein are intended for explanatory purposes and is not intended to unduly limit the scope of the claimed inventions. Other embodiments and applications not described herein are considered to be within the scope of the claimed inventions.

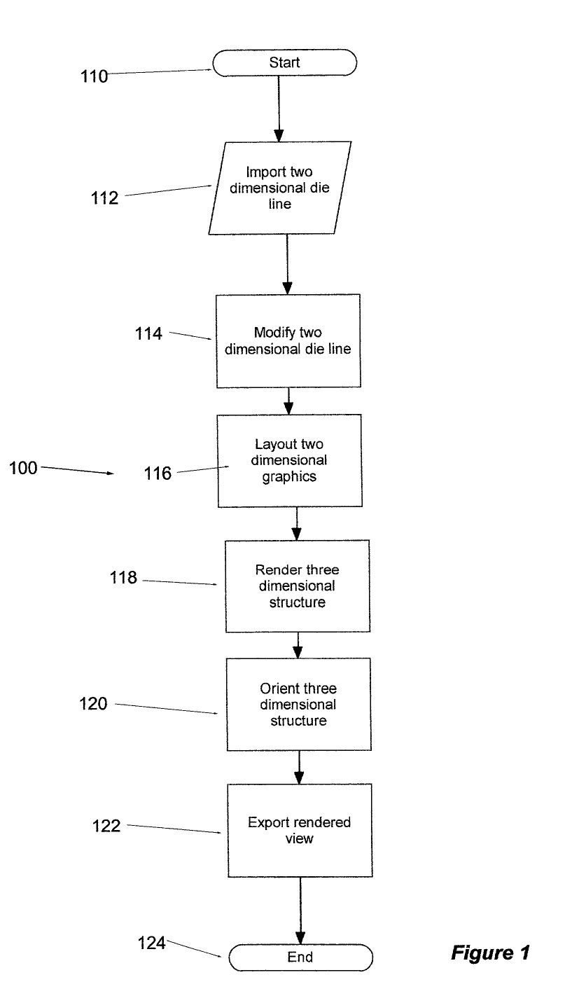

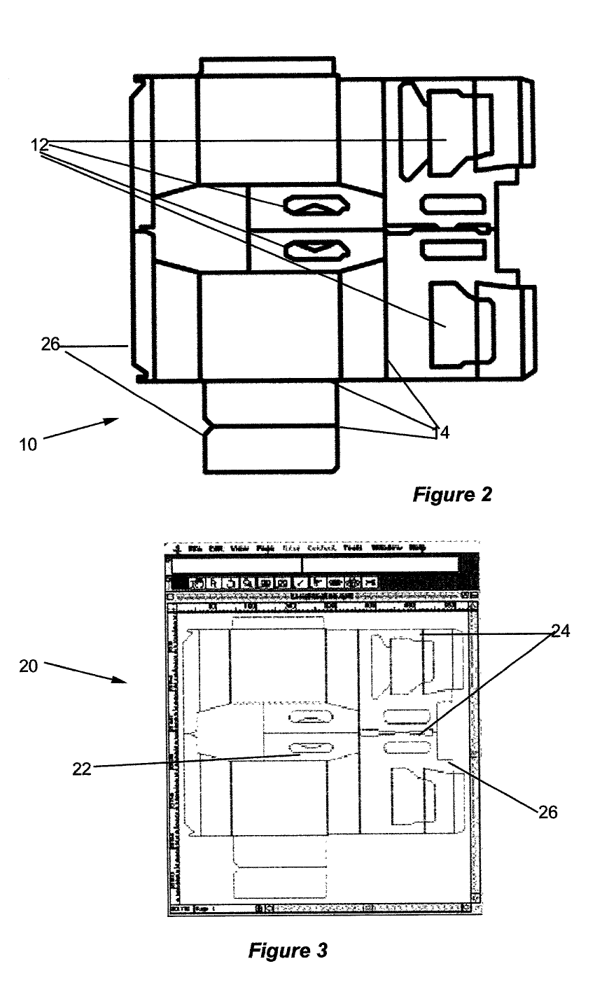

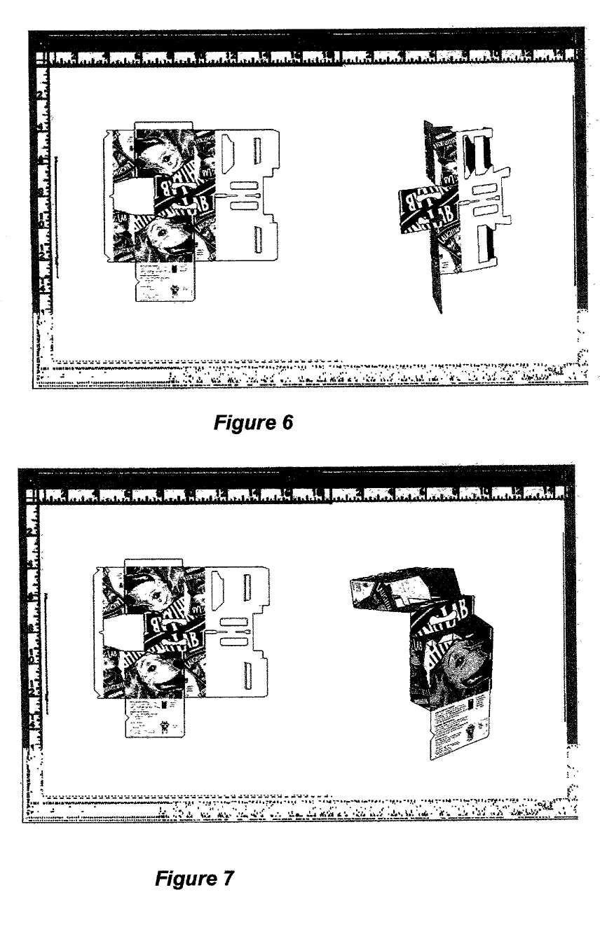

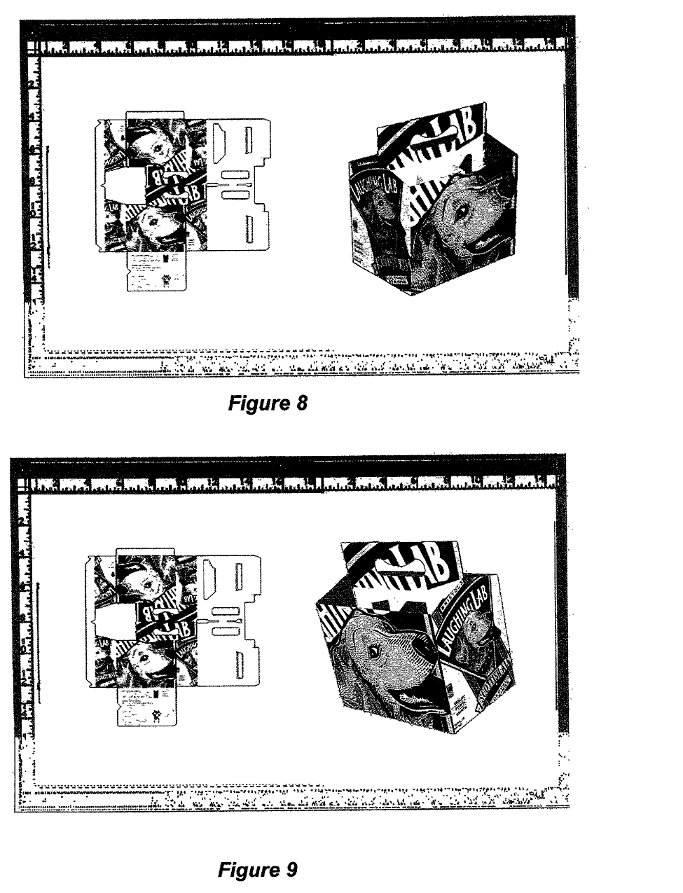

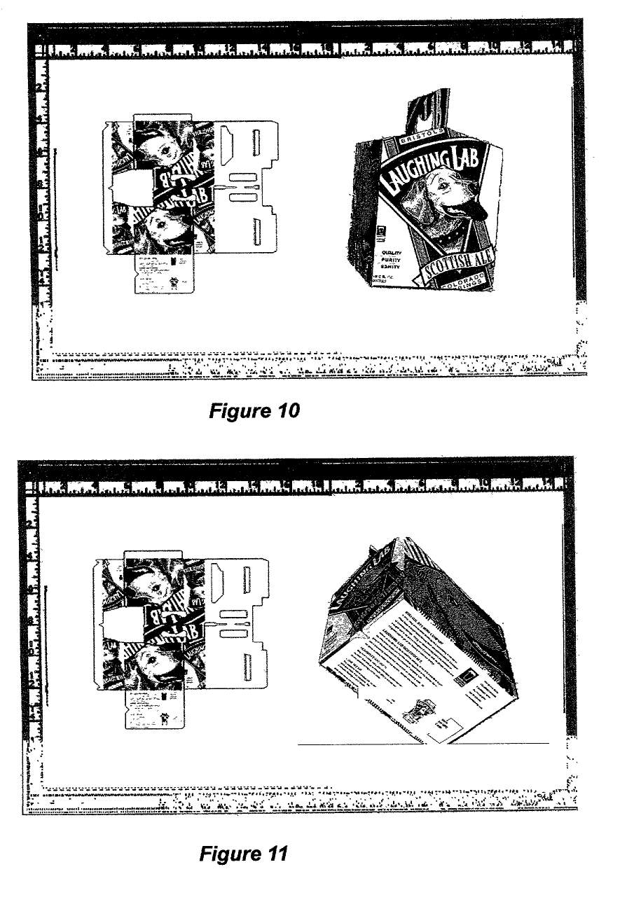

An implementation of a preferred embodiment of the present invention is illustrated in FIGS. 1-12. An overview of this preferred embodiment is illustrated in the flowchart in FIG. 1. Initially, a structural die-line drawing, such as drawing 10 in FIG. 2 is either created directly in the system, or more typically, created on Computer Aided Design software and saved in EPS format. The system, as shown at 112, is able to import the die lines of this drawing. The drawing can be opened into the system, as shown in FIG. 3. The two-dimensional structural die-line drawing is then modified (114) as necessary, either to repair mistakes or to modify the packaging. Two-dimensional graphics, text and/or other content may then be placed in the modified two-dimensional drawing in a “lay-out” process (116). The modified two-dimensional drawing, along with the content, is then rendered (118) into a three-dimensional structure. This three-dimensional structure can then be oriented (120) to view different angles and perspectives. A view of the three-dimensional structure can then be exported (122) in a variety of formats.

This preferred embodiment can be implemented in a variety of techniques. These techniques may include widely available technology, proprietary technology and future-developed technology. These technologies may include CAD systems, such as Auto-Cad and other computer aided design systems, layout systems such as QuarkXPress, rendering technology and export technology. The inventions, as set forth in the claims, is not intended to be limited to the technology described in the exemplary preferred embodiments but includes other technology presently available and future developed for the intended functions.

An example of a two-dimensional die line drawing 10 is illustrated in FIG. 2. This structural drawing 20 is intended to form a six-bottle container. It is to be expressly understood that other shapes other than the illustrated drawing are within the scope of the claimed invention. Other configurations beyond packages may be included as well. Almost any configuration that can be created from a two-dimensional form may be used under the preferred embodiment of the present invention. These can include packages, boxes, table tents, display cases, cd-rom cases, bottles, cans, and any other shape or configuration.

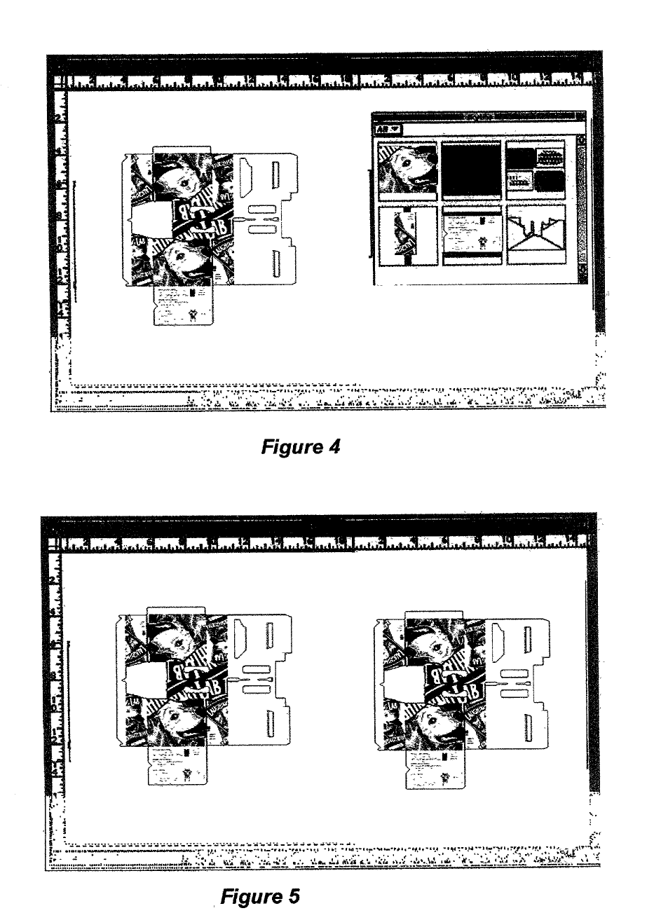

The die-line drawing 10 includes cut lines 12, crease lines 14, and boundary lines 16. These cut lines, crease lines and boundary lines of the original die line structural drawing are converted into guide lines in two-dimensional structural drawing 20 in FIG. 3, as indicated in FIG. 1 at process element 112. Images, text and other design elements can be “snapped” to these guide lines to ensure precise alignment of these elements during the layout process, as shown in FIG. 4. In the preferred embodiment, the different die lines are shown in different colors, widths, dashing or other distinguishing features. The guides can be added or adjusted as desired, at any angle including Bezier lines.

Another unique feature of this preferred embodiment of the present invention is the ability to save any changes to the die lines. If the die lines are edited, these modifications can be saved back to their original format or exported to that format for use.

Design elements 30 can now be inputted into the structural drawing 20 by simply “dragging and dropping” as shown in FIG. 1, at process element 116. The elements are inserted into the appropriate location on the structural drawing. Other mechanisms for inputting design elements into the drawings 20 can be used as well. The design elements can be created from the system, selected from a library or created from another program. These design elements can be graphics, text, colors, textures, backgrounds, and any other design element. The designer can create boxes, curved lines, and text paths with Bezier and freehand drawing tools. The designer can wrap text around boxes, lines, clipping paths, and alpha channels. Text can be formatted quickly and consistently with paragraph and character style sheets. The color and contrast of a variety of bitmap styles. Trapping tools are built into the system. Spot and process colors can be applied in accordance with most color models. Other design and word processing tools can be utilized as well.

A mock-up three-dimensional rendering of the structural drawing with some or all of the design elements added to it can be displayed. The three-dimensional view of the structural drawing folded, assembled or otherwise created in the shape of the final package is rendered, as shown at process element 118 in FIG. 1 with design elements added to it as laid out in the previous step. The rendering operation of element 118 is discussed in greater detail below. The folding and assembling of the two-dimensional structural drawing into a three-dimensional product view is shown in FIGS. 5-8. The mockup can be viewed from any angle or viewpoint, as shown at process element 120 in FIG. 1 and as illustrated in FIGS. 9-11. The mockup image can also be resized interactively as desired.

In the preferred embodiment, the resolution of the mockup palette can be adjusted by adjusting the resolution setting of the monitor being used, by adjusting the sampling rate for rescanning the pixels displayed on-screen through the anti-aliasing of the system, by using a font manager and by setting the bit depth of imported color images.

The designer can make changes to the design elements based upon this view of the mockup. Structural changes can also be made at this time. For example, a cut-out window may be added to the structural drawing by inputting the cut-out from a library or template into the structural drawing. This change is then shown in the updated mockup.

Diagnostic tools are also included to minimize errors in the design process. For example, if a die line is not correct, or if the designer makes a change that compromises the integrity of the die line, the system will alert the designer.

The folding and/or assembly process can be animated and exported in a variety of formats, such as QuickTime, QuickTime VR, JPEG or other formats. The structural drawing 20 is folded in accordance with the crease lines 22, and cut-outs formed in accordance with the cut lines 24. The design elements are already “fused” onto the structural drawings.

The mockup can be saved and exported in a variety of formats, shown at process element 122 in FIG. 1, so that others viewing the images do not need the present system. In the preferred embodiment, the mockup can be exported in JPEG, Quicktime movie, or Quicktime Virtual Reality formats, as well as other formats presently available or later developed. This allows the mockup to be viewed by others, such as clients, focus groups, editors, design presentations, product marketing, product comparisons and other uses. The exported files can be showcased on an HTML page with other design options. Input can then be received and changes made if desired. An updated die line structure can be exported to the die cutter to add any structural changes to the package.

Once the design has been finalized, the design files can be collected. The design files can be sent in EPS format to the printer for printing the uncut package sheets.

In the preferred embodiment, packages are discussed. It is to be expressly understood that other three-dimensional structures created from die lines can be designed as well from the present system. For example, promotional table tents, direct mail pieces, envelopes with transparent windows, point of purchase displays, point of sale displays, and other structural pieces.

Other preferred embodiments are able to accommodate flexible and irregular surfaces in addition to the flat surfaces discussed above. Also, variable shapes and transparent materials are used in other preferred embodiments.

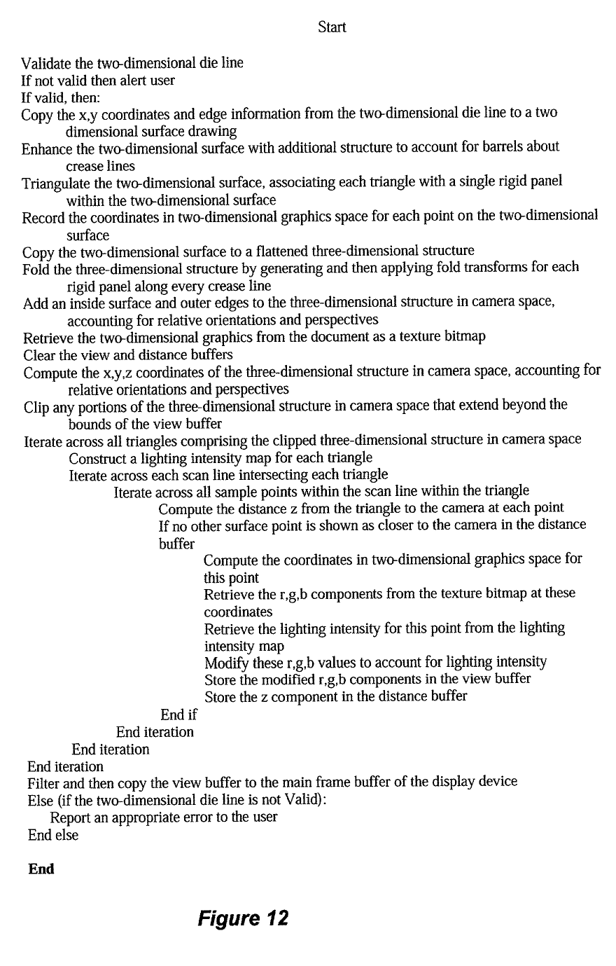

The process of “rendering” the three-dimensional images of process element 118, shown in the flowchart of FIG. 1, may be accomplished by technology presently known or as later developed. In the preferred embodiment, an optimized version of Phong shading is used, but other models may be used as well. An example of a preferred embodiment of the present invention for rendering or creating the three-dimensional structure from the two-dimensional layout of the packaging graphics is illustrated in FIG. 12. The system 500 is started 510 at process element 140 of the process illustrated in the flowchart of FIG. 1 to create the view of the three-dimensional structure. A check is done at 512 to ensure that the two-dimensional die line is a plausible structure for creating a three-dimensional structure. If the two-dimensional die line is not valid, then an error message 514 is reported to the user, and the die line is repaired. If the two-dimensional die line is valid, then subroutine 520 is executed. In subroutine 520, the system first copies (522) the x,y coordinates and edge information from the two-dimensional die line to a two-dimensional surface. Then, at 524, the two-dimensional surface is enhanced with additional structure to account for barrels about crease lines. The two-dimensional surface is then triangulated (526) and each triangle is associated with a single rigid panel within the two-dimensional surface. The x,y coordinates are recorded in two-dimensional graphics space for each point on the two-dimensional surface (528). The system then copies (530) the two-dimensional surface to a flattened three-dimensional structure. The three-dimensional structure is then folded (532) by generating and then applying fold transforms for each rigid panel along every crease line. An inside surface and outer edges is added (534) to the three-dimensional structure by extruding the folded structure to account for thickness.

The two-dimensional graphics are retrieved (536) from the document as a texture bitmap. The view and distance buffers are then cleared (538). The x,y,z coordinates of the three-dimensional structure are computed (540) in camera space, accounting for relative orientations and perspective. Any portions of the three-dimensional structure in camera space that extend beyond the bounds of the view buffer are clipped (542).

All triangles comprising the clipped three-dimensional structure in camera space are iterated across in subroutine 550. In this subroutine, a lighting intensity map for each triangle is constructed (552). An iteration across each scan line intersecting each triangle is performed at subroutine 560. In this subroutine, an iteration across all sample points within the scan line within each of the triangles is performed (562). This is done by computing the distance (z) from the triangle to the camera at each point (564). If no other surface point is shown as closer to the camera in the distance buffer, then subroutine 570 is performed. The coordinates in two-dimensional graphics space for this point are computed (572). Then the (r,g,b) components from the texture bitmap at these coordinates is retrieved (574). The lighting intensity for this point is retrieved (576) from the lighting intensity map. These (r,g,b) values are modified to account for lighting intensity (578) and stored in the view buffer (580). The (z) component is also stored (582) in the distance buffer. The iteration for subroutine 570 for that surface point is then ended (584), and restarted for the next surface point until all surface points for a particular scan line have been computed.

The surface points for the next scan line then undergoes a similar computation until all scan lines for a particular triangle have been processed (588). The scan lines for the next triangle is then processed until all triangles have been processed (590). Once the lighting intensity has been computed, the system then filters and copies (592) the view buffer to the main frame buffer of the display device.

It is to be expressly understood that other techniques for rendering a three-dimensional structure from a two-dimensional structural drawing may be utilized under the present invention. Other techniques may provide additional benefits as well. In the preferred embodiment, the rendering technique provides support for perspective correction, clipping and anti-aliasing as well as for 8-bit, 16-bit and 24-bit color models. In this preferred embodiment, variable viewing characteristics such as focal length, screen size and background color are included, as well as variable lighting characteristics such as intensities for ambient light, point source at a fixed distance and other such characteristics. Objects are represented as a collection of triangulated rigid bodies with surface characteristics that include ambient, diffuse and specular properties. The objects can be freely positioned independent of camera orientation. The surfaces can be represented by solid colors of by texture maps.

Other preferred embodiments of the present invention include the ability to scale the two-dimensional structural drawings and three-dimensional mock-ups to allow for large documents, such as 96 inches by 96 inches. The system of this preferred embodiment “tiles” the finished sheets, if necessary so it can be used on most printers. Also, in order to speed the design process, character and paragraph style sheets are supported to allow text to be quickly formatted. In one preferred embodiment, the three-dimensional mock-ups may be customized by changing the lighting, camera and background color settings.

In one preferred embodiment, the system supports the ability to render three-dimensional mock-ups having multiple pieces that can be separately and jointly manipulated. This is useful in designing multiple piece packaging such as a six-pack container with individual bottles. The bottles can be separately designed, added to the container and removed from the container.

Another alternative preferred embodiment includes a library of structural materials, such as paper, cardboard, corrugated materials, etc. that can be used. The system automatically calculates and visualizes the appropriate thickness, textures and other characteristics for these materials.

It is to be expressly understood that the claimed inventions are not intended to be limited by these descriptive embodiments. Other features and embodiments, not only presently available but as later developed in the future are encompassed by the scope of the appended claims.

1. A process for designing packaging, said system comprising:
converting die line drawings into two-dimensional structural drawings so that the die lines are converted into guide lines;
inputting design elements into said structural drawings;
rendering a three dimensional image based on said two-dimensional structural drawings; and
exporting views of said rendered three dimensional image in formats viewable by other users.

2. The process of claim 1 wherein said process further includes:
validating said die line drawings to ensure structural integrity of a three-dimensional structure formed from said die line drawings.

3. A system for designing packaging, said system comprising:
means for converting die line drawings into two-dimensional structural drawings so that the die lines are converted into guide lines;
means for inputting design elements into said structural drawings;
means for rendering a three dimensional image based on said two-dimensional structural drawings; and
means for exporting views of said rendered three dimensional image in formats viewable by other users.
